(19) United States
(12) Patent Application Publication
(10) Pub. No.: US 2025/0246182 A1
(43) Pub. Date: Jul. 31, 2025

(54) CONVERSATION SUPPORT DEVICE, CONVERSATION SUPPORT SYSTEM, CONVERSATION SUPPORT METHOD, AND STORAGE MEDIUM

(71) Applicant: HONDA MOTOR CO., LTD., Tokyo (JP)

(72) Inventors: Naoaki Sumida, Wako-shi (JP); Masaki Nakatsuka, Wako-shi (JP); Yui Sudo, Wako-shi (JP); Akihiko Konsha, Tokyo (JP); Kazuya Maura, Hayami-gun (JP); Kyosuke Hineno, Hayami-gun (JP); Yuri Harada, Hayami-gun (JP)

(21) Appl. No.: 19/023,455

(22) Filed: Jan. 16, 2025

(30) Foreign Application Priority Data
Jan. 25, 2024 (JP) 2024-009778

(51) Int. Cl. G10L 15/08; G10L 15/22; G10L 15/30

(52) U.S. Cl. CPC G10L 15/08; G10L 15/22; G10L 15/30

(57) ABSTRACT

A conversation support device includes: an acquisition unit configured to acquire speech; a display unit configured to display text based on the acquired speech; and a control unit configured to cause the display unit to display the text based on the speech. The control unit recognizes a piece of text selected by a user out of a plurality of pieces of the text displayed on the display unit as designated text. The control unit causes the display unit to display speech associated with the designated text in correlation with the designated text when the speech associated with the designated text is input in a state in which the designated text has been recognized.

### CROSS-REFERENCE TO RELATED APPLICATION

Priority is claimed on Japanese Patent Application No. 2024-009778, filed Jan. 25, 2024, the content of which is incorporated herein by reference.

### BACKGROUND OF THE INVENTION

### Field of the Invention

The present invention relates to a conversation support device, a conversation support system, a conversation support method, and a storage medium.

### Description of Related Art

A conference support system that recognizes speech spoken by participants and displays the recognized speech on a screen has been proposed (for example, see Patent Document 1). In such a system, since speech of the participants is recognized, converted to text, and displayed on screens of mobile terminals or the like of the participants, it is useful for a participant or the like who is a hearing-impaired person and participates in the conference. In such a system, an intention of a hearing-normal person can be appropriately delivered to a hearing-impaired person.

[Patent Document 1] Japanese Patent No. 6548045

### SUMMARY OF THE INVENTION

However, in the related art, speech is displayed in a time series on the screen. Accordingly, when it is intended to go back to speech earlier than immediately previous speech, since the speech is merely displayed in a time series, it is not easy to understand the context.

An aspect of the present invention was invented in consideration of the aforementioned circumferences, and an objective thereof is to provide a conversation support device, a conversation support system, a conversation support method, and a storage medium that can facilitate understanding of a comment in context when speech spoken or text input by a participant is previous speech.

In order to solve the aforementioned problem and to achieve the objective, the present invention employs the following aspects.
(1) A conversation support device according to an aspect of the present invention includes: an acquisition unit configured to acquire speech; a display unit configured to display text based on the acquired speech; and a control unit configured to cause the display unit to display the text based on the speech, wherein the control unit recognizes a piece of text selected by a user out of a plurality of pieces of text displayed on the display unit as designated text, and wherein the control unit causes the display unit to display speech associated with the designated text in correlation with the designated text when the speech associated with the designated text is input in a state in which the designated text has been recognized.
(2) The conversation support device according to the aspect of (1) may further include a text conversion unit configured to convert the speech to text when the speech is a voice signal, the acquisition unit may acquire a voice signal when the speech is a voice signal and acquires text when the speech is text, and the control unit may assign identification information to the converted text or the acquired text and cause the display unit to display the speech associated with the designated text in correlation with the designated text on the basis of the identification information of the text designated by a user out of the plurality of pieces of text displayed on the display unit.
(3) In the aspect of (1) or (2), the control unit may display the speech associated with the designated text in an area in which the designated text is displayed.
(4) In the aspect of any one of (1) to (3), the control unit may cause the display unit to thread-display a relationship between the speech associated with the designated text and the designated text when a thread display instruction is given.
(5) In the aspect of any one of (1) to (4), the designated text may be full or partial text of the speech.
(6) A conversation support system according to another aspect of the present invention includes a terminal and a conference support device, the terminal includes an acquisition unit configured to acquire speech, a display unit configured to display text based on the acquired speech, and a processing unit configured to transmit information on the acquired speech to the conference support device, to acquire the text based on the speech, to cause the display unit to display the text acquired from the conference support device, to recognize a piece of text selected out of a plurality of pieces of the displayed text as designated text, to transmit information indicating the designated text and speech associated with the designated text to the conference support device when the speech associated with the designated text is input in a state in which the designated text has been recognized, and to cause the display unit to display comment display information in which the information indicating the designated text and the speech associated with the designated text are correlated and which is acquired from the conference support device, and the conference support device includes a conversion unit configured to convert a voice signal to text when the speech acquired from the terminal is the voice signal, a comment generating unit configured to acquire information indicating the designated text and speech associated with the designated text and to generate the comment display information in which the speech associated with the designated text is correlated with the designated text, and a processing unit configured to transmit the generated comment display information to the terminal.
(7) A conversation support method according to another aspect of the present invention includes: causing an acquisition unit to acquire speech; causing a display unit to display text based on the acquired speech; causing a control unit to recognize a piece of text selected by a user out of a plurality of pieces of the text displayed on the display unit as designated text; and causing the control unit to display speech associated with the designated text in correlation with the designated text when the speech associated with the designated text is input in a state in which the designated text has been recognized.
(8) A non-transitory computer-readable storage medium according to another aspect of the present invention stores a program causing a computer to perform: acquiring speech; generating text based on the acquired speech to be displayed; displaying the text on a display unit; recognizing a piece of text selected by a user out of a plurality of pieces of the text displayed on the display unit as designated text; and displaying speech associated with the designated text on the display unit in correlation with the designated text when the speech associated with the designated text is input in a state in which the designated text has been recognized.

According to the aspects of (1) to (8), when speech made or text input by a participant is previous speech, it is possible to facilitate understanding of a comment in context.

According to the aspect of (4), since a comment and a target of the comment can be thread-displayed, it is possible to facilitate understanding of the comment in context.

### BRIEF DESCRIPTION OF THE DRAWINGS

FIG. 1 is a diagram illustrating a summary of a conversation support system according to an embodiment and an image of a conference.

FIG. 2 is a diagram illustrating an example of an image and an example of an operation which are displayed on a terminal according to an embodiment.

FIG. 3 is a diagram illustrating an example of information that is transmitted to a terminal by a conference support device according to an embodiment.

FIG. 4 is a block diagram illustrating an example of a configuration of a conversation support system according to a first embodiment.

FIG. 5 is a flowchart illustrating a process flow that is performed by the conversation support system according to the first embodiment.

FIG. 6 is a diagram illustrating an example of an image and an example of an operation which are displayed on a terminal according to a second embodiment.

FIG. 7 is a flowchart illustrating a process flow that is performed by a conversation support system according to the second embodiment.

### DETAILED DESCRIPTION OF THE INVENTION

Hereinafter, embodiments of the present invention will be described with reference to the accompanying drawings. In the drawings used for the following description, scales of elements are appropriately changed to easily recognize the elements.

In all the drawings used for description of the embodiments, elements having the same or similar functions will be referred to by the same reference signs, and repeated description thereof will be omitted.

“On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

### Summary of Conversation Support System and Summary of Embodiments

A summary of a conversation support system and a summary of embodiments will be first described below.

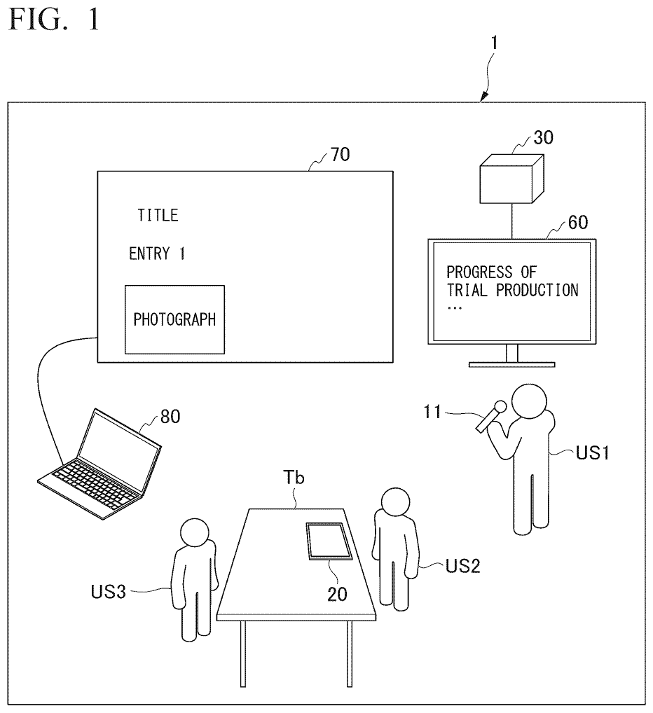

FIG. 1 is a diagram illustrating a summary of a conversation support system according to an embodiment and an image of a conference.

A conversation support system 1 is used, for example, in a conference in which two or more persons participate. A participant (for example, a hearing-impaired person) US2 who is speaking or hearing impaired may be included in participants US1 to US3 in a conference. All the participants may not be present in the same conference room, and some participants may participate in the conference from different conference rooms, home, or the like, for example, via a network NW.

Each of participants US1 and US3 who can speak wears a sound collecting unit 11. For example, a participant US2 who is hearing-impaired carries a terminal (such as a smartphone, a tablet terminal, or a personal computer) 20 (a conversation support device). A conference support device 30 recognizes a voice signal of speech of a participant, converts the voice signal to text, and displays the text on a first display device 60 (display device) and a terminal 20. A personal computer (PC) 80 or the like for displaying explanation materials is connected to a second display device 70. The participant US2 uses the terminal 20 placed, for example, on a table Tb.

In the related art, when a participant makes voice or text comments on spoken details, the participants cannot know whether the comment is a comment on immediately previous speech or a comment on that previous to immediately previous speech.

Accordingly, in embodiments, a comment target (text of original speech of a comment) is selected by a user using the terminal 20, and a comment on the comment target is made by voice or text. In the embodiments, the comment is converted to text, and the text is displayed in an area in which the text is displayed in correlation with text as the comment target. Accordingly, in the embodiments, when speech uttered by a participant or text input by the participant is previous speech, it is possible to easily understand the context of the comment.

### First Embodiment

### [Example of Operation and Display of Terminal]

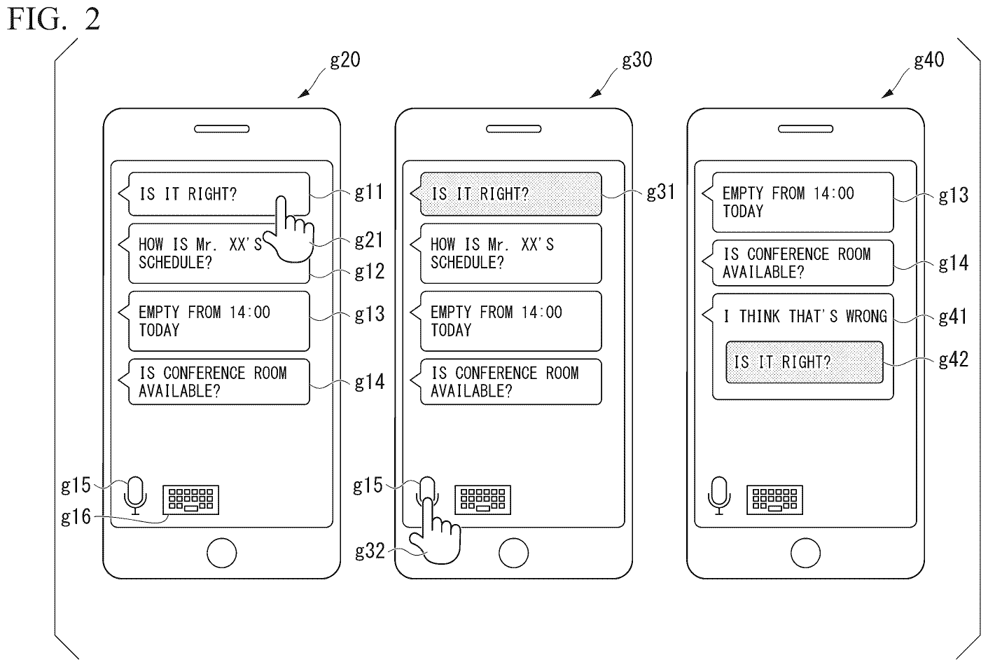

An example of an image and an example of an operation displayed on the terminal 20 will be described below with reference to FIG. 2. FIG. 2 is a diagram illustrating an example of an image and an example of an operation which are displayed on a terminal according to a first embodiment.

In FIG. 2, images g11 to g14 are images obtained by causing the conference support device 30 to recognize first to fourth speech and to convert the speech to text. An image g15 is an example of a voice recognition button image which is selected by a user when spoken details of the user of the terminal 20 are recognized. An image g16 is an example of a text input button image which is selected by a user when the user of the terminal 20 inputs spoken details as text.

Text of speech which is displayed on a display unit of the terminal 20 is transmitted from the conference support device 30 to the terminals 20. Then, the conference support device 30 assigns, for example, identification numbers for identifying speech sequentially from the start of the conference to the speech, assigns identification numbers to text, and transmits the text and the identification numbers to the terminals.

(Before operation) An image g20 is a first screen. In the first screen, the first to fourth speech is displayed in a time series. In this example, a user who wants to comment on the first speech selects the image g11 of the first speech. An image g21 is an image of a user's finger.

(Operation 1) An image g30 is a second screen. In order to indicate that the first speech has been selected as designated text, for example, display such as a color of a text display area is changed as in an image g31. The change in display may be realized, for example, by displaying the text in bold letters, underlining the text, or italicizing the text. Then, a user of the terminal makes a spoken comment and selects a speech recognition button image g15 to recognize his or her own speech (an image g32).

(After operation) An image g40 is a third screen. The third screen is an example of an image which is displayed by commenting on a comment target by speech, recognizing the comment speech, and converting the recognized speech to text. An image g41 is an example of an image in which text of a comment on the first speech is displayed. The image g41 indicates the text of the first speech selected in the second image. In this embodiment, in order to indicate on which of a plurality of pieces of speech a user has commented, the speech on which the user has commented is also displayed in a comment display area g41 of the speech on which a comment is made as in the image g40.

In the example described above with reference to FIG. 2, a user comments on spoken details by speech, but the present invention is not limited thereto. The user may input the comment as text by selecting the text input button image g16.

In FIG. 2, the terminal 20 may display an image of an icon, a name, or the like indicating a speaker in correlation with text of each piece of speech.

### [Example of Information Transmitted to Terminal]

An example of information which is transmitted from the conference support device 30 to the terminal 20 will be described below.

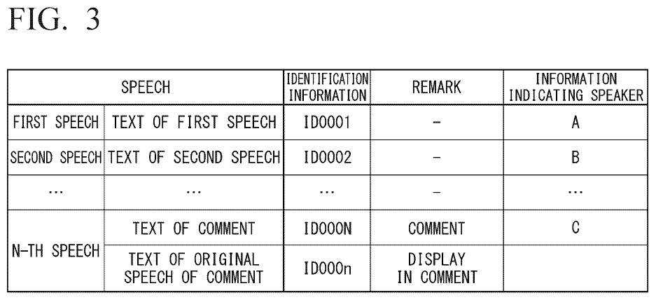

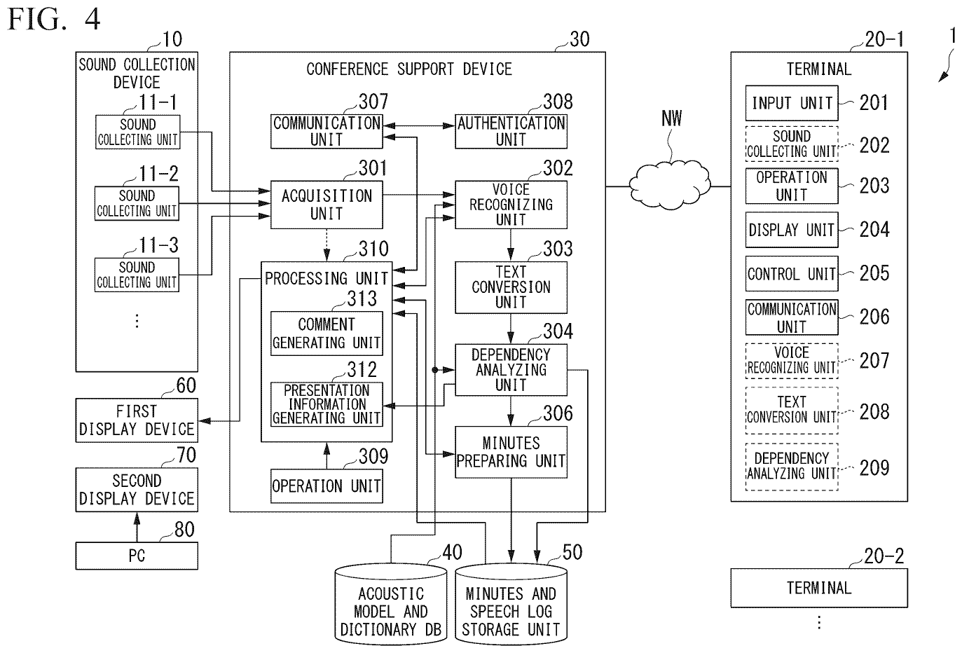

FIG. 3 is a diagram illustrating an example of information which is transmitted from the conference support device to the terminal according to this embodiment. As illustrated in FIG. 3, the conference support device 30 assigns, for example, identification information and information indicating a speaker to text obtained by recognizing speech and converting the speech to text in the order of speech, stores the resultant text, for example, in a minutes and speech log storage unit 50 (FIG. 4), and transmits the resultant text to the terminal 20.

When a user comments on speech as in the image g40 illustrated in FIG. 2, the conference support device 30 assigns an identification number to the comment and adds information indicating a comment to the comment as in the N-th speech. The conference support device 30 adds information indicating display in a comment to original text of the comment. The conference support device 30 stores “text of a comment, identification of the comment, and information (remark information) indicating a comment” and “text of original speech of a comment, identification information of the text of the original speech of the comment, and information (remark information) indicating display in the comment,” for example, in the minutes and speech log storage unit 50 and transmits such information to the terminal 20. At the time of transmission of information on a comment, the conference support device 30 may transmit information indicating an original speaker of the comment in addition to the information indicating a speaker of the comment. Accordingly, according to the present embodiment, it is possible to easily understand on whose speech a comment has been performed.

The terminal 20 updates information which is displayed on a display unit 204 (FIG. 4) whenever such information is acquired from the conference support device 30. When remark information is added, the terminal 20 displays the original text of the comment in a text display area of the comment.

### [Example of Configuration of Conversation Support System]

An example of a configuration of the conversation support system 1 will be described below.

FIG. 4 is a block diagram illustrating an example of a configuration of the conversation support system according to the present embodiment. As illustrated in FIG. 4, the conversation support system 1 includes, for example, a sound collection device 10, a terminal 20, a conference support device 30, an acoustic model and dictionary DB 40, a minutes and speech log storage unit 50, first display device 60, a second display device 70, and a PC 80. The terminal 20 includes a terminal 20-1, a terminal 20-2, . . . . In the following description, when one of the terminal 20-1 and the terminal 20-2 is not identified, the terminals are referred to as a “terminal 20.”

The sound collection device 10 includes a sound collecting unit 11-1, a sound collecting unit 11-2, a sound collecting unit 11-3, . . . . In the following description, when one of the sound collecting unit 11-1, the sound collecting unit 11-2, the sound collecting unit 11-3, . . . is not identified, the sound collecting units are referred to as a sound collecting unit 11.”

The terminal 20 includes, for example, an input unit 201, a sound collecting unit 202, an operation unit 203, a display unit 204, a control unit 205, and a communication unit 206.

The conference support device 30 includes, for example, an acquisition unit 301, a voice recognizing unit 302, a text conversion unit 303, a dependency analysis unit 304, a minutes preparing unit 306, a communication unit 307, an authentication unit 308, an operation unit 309, and a processing unit 310. The processing unit 310 includes, for example, a presentation information generating unit 312 and a comment generating unit 313.

The sound collection device 10 and the conference support device 30 are connected in a wired or wireless manner. The terminal 20 and the conference support device 30 are connected via a wired or wireless network NW. An imaging device 90 and the conference support device 30 are connected via a wired or wireless network NW.

### [Sound Collection Device]

The sound collection device 10 collects a voice signal uttered by a participant and outputs the collected sound signal to the conference support device 30. The sound collection device 10 may include one microphone array. In this case, the sound collection device 10 includes P microphones which are provided at different positions. The sound collection device 10 generates voice signals of P channels (where P is an integer equal to or greater than 2) from the collected sound and output the generated voice signals of P channels to the conference support device 30.

The sound collecting unit 11 is a microphone. The sound collecting unit 11 collects a voice signal of a participant, converts the collected voice signal from an analog signal to a digital signal, and outputs the voice signal converted to the digital signal to the conference support device 30. The sound collecting unit 11 may output the voice signal which is an analog signal to the conference support device 30. The collected voice signal includes data of an imaging time.

### [Terminal]

The terminal 20 is, for example, a smartphone, a tablet terminal, a laptop computer. The terminal 20 may include, for example, a motion sensor and a global positioning system (GPS).

The input unit 201 is, for example, a touch panel type sensor (including a touch panel pencil) provided on the display unit 204 or a keyboard. The input unit 201 detects an input from a participant and outputs the detection result to the control unit 205. For example, a user of the terminal 20 inputs text by hand using the touch panel pencil, inputs text by operating a software keyboard displayed on the display unit 204, or inputs text by operating a mechanical keyboard.

The sound collecting unit 202 is a microphone. The sound collecting unit 202 collects a voice signal of the user of the terminal 20.

The operation unit 203 is, for example, a touch panel sensor that is provided on the display unit 204. The operation unit 203 detects the user's operation.

The display unit 204 displays image data that is output from the control unit 205. The display unit 204 is, for example, a liquid crystal display device, an organic electroluminescence (EL) display device, or an electronic ink display device.

The control unit 205 acquires text input by the user on the basis of the result output from the input unit 201. The control unit 205 acquires the user's voice signal when the voice recognition button image is selected. When the terminal 20 does not include the sound collecting unit 202, the control unit 205 may transmit an instruction for the sound collection device 10 to collect the user's voice signal to the conference support device 30 when the voice recognition button image is selected.

When speech on which the user wants to comment is selected through an operation of the operation unit 203, the control unit 205 outputs information indicating the selected speech to the conference support device 30. The control unit 205 displays text or the like on the display unit 204 on the basis of information (FIG. 3) acquired from the conference support device 30.

All of some of applications which are used for processing of the control unit 205 may be provided, for example, in cloud.

The communication unit 206 receives information such as the text from the conference support device 30 and outputs the received information to the control unit 205. The communication unit 206 transmits the text and the voice signal output from the control unit 205 to the conference support device 30.

### [Acoustic Model and Dictionary DB and Minutes and Speech Log Storage Unit]

For example, an acoustic model, a language model, and a word dictionary are stored in the acoustic model and dictionary DB 40. An acoustic model is a model based on feature quantities of sound, and a language model is a model of information on words and an arrangement method thereof. A word dictionary is a dictionary of a plurality of words and is, for example, a large vocabulary word dictionary. The conference support device 30 may store a word or the like not stored in the voice recognition dictionary 13 in the acoustic model and dictionary DB 40 and update the acoustic model and dictionary DB 40.

The minutes and speech log storage unit 50 stores minutes (including a voice signal including).

The acoustic model and dictionary DB 40 or the like may be provided in a server (not illustrated) or may be provided in cloud.

The first display device 60 displays image data output from the conference support device 30. The first display device 60 is, for example, a liquid crystal display device, an organic electroluminescence (EL) display device, or an electronic ink display device. The first display device 60 may be provided in the conference support device 30.

The second display device 70 displays image data that is output from the PC 80. The second display device 70 is, for example, a liquid crystal display device, an organic electroluminescence (EL) display device, or an electronic ink display device. The second display device 70 may be provided in the PC 80.

The PC 80 is, for example, one of a personal computer, a smartphone, and a tablet terminal.

### [Conference Support Device]

The conference support device 30 is, for example, one of a personal computer, a server, a smartphone, and a tablet terminal. When the sound collection device 10 is a microphone array, the conference support device 30 further includes a sound source localizing unit, a sound source separating unit, and a sound source identifying unit. The conference support device 30 recognizes a voice signal uttered by a participant and converts the voice signal to text, for example, every predetermined period. The conference support device 30 transmits text information of speech details converted to the text (identification information including the text or information indicating a speaker, see FIG. 3) to the terminals 20 of the participants.

The acquisition unit 301 acquires a voice signal output from the sound collecting unit 11 and outputs the acquired voice signal to the voice recognizing unit 302. The acquisition unit 301 acquires a voice signal transmitted from the terminal 20 and outputs the acquired voice signal to the voice recognizing unit 302. When the acquired voice signal is an analog signal, the acquisition unit 301 converts the analog signal to a digital signal and outputs the voice signal converted to the digital signal to the voice recognizing unit 302.

When the number of sound collecting units 11 is two or more, the voice recognizing unit 302 performs voice recognition for each speaker who uses the corresponding sound collecting unit 11.

The voice recognizing unit 302 acquires the voice signal output from the acquisition unit 301. The voice recognizing unit 302 detects a voice signal in a speech section from the voice signal output from the acquisition unit 301. In detection of a speech section, for example, a voice signal which is equal to or greater than a predetermined threshold value may be detected as a speech section, or an ON state and an OFF state of the sound collecting unit 11 may be detected. The voice recognizing unit 302 performs voice recognition of the voice signal in the detected speech section using a known method with reference to the acoustic model and dictionary DB 40. The voice recognizing unit 302 may detect a speech section using another known method. The voice recognizing unit 302 performs the voice recognition, for example, using the method disclosed in the Japanese Unexamined Patent Application, First Publication No. 2015-64554. The voice recognizing unit 302 outputs the recognition result and the recognized voice signal to the text conversion unit 303. The voice recognizing unit 302 outputs the recognition result and the voice signal in correlation, for example, for each sentence, for each speech section, or for each speaker to the text conversion unit 303.

The text conversion unit 303 converts the voice signal to text on the basis of the recognition result output from the voice recognizing unit 302. The text conversion unit 303 outputs the converted text information and the voice signal to the dependency analysis unit 304. The text conversion unit 303 may delete interjections such as “Ah-,” “Uhh-,” “Um-,” and “Oh-” and convert the resultant signal to text.

The dependency analysis unit 304 performs morpheme analysis and dependency analysis on the text information output from the text conversion unit 303. In dependency analysis, for example, an SVM is used for a shift-reduce method, a spanning tree technique, or a chunk ID stepwise application technique. When correction is needed on the basis of the analysis result, the dependency analysis unit 304 corrects the recognized text information with reference to the acoustic model and dictionary DB 40 and stores the text information in the minutes and speech log storage unit 50. The dependency analysis unit 304 outputs the text information which is the dependency analysis result and the voice signal to the minutes preparing unit 306.

The minutes preparing unit 306 prepares minutes for each speaker such as a presenter on the basis of the text information and the voice signal output from the dependency analysis unit 304. The minutes preparing unit 306 stores the prepared minutes and the corresponding voice signal in the minutes and speech log storage unit 50. The minutes preparing unit 306 may delete interjections such as “Ah-,” “Uhh-,” “Um-,” and “Oh-” and prepare the minutes.

The communication unit 307 transmits and receives information to and from the terminal 20. The information received from the terminal 20 includes, for example, a request for participation in a conference, text input start information, text transmission information, and instruction information for requesting transmission of past minutes. The communication unit 307 extracts, for example, identification information for identifying the terminal 20 from the request for participation received from the terminal 20 and outputs the extracted identification information to the authentication unit 308. The identification information is, for example, a serial number of the terminal 20, a media access control (MAC) address, or an Internet protocol (IP) address. When the authentication unit 308 outputs an instruction for permitting participation in communication, the communication unit 307 communicates with the terminal 20 having transmitted the request for participation in the conference. When the authentication unit 308 outputs an instruction for not permitting participation of communication, the communication unit 307 does not communicate with the terminal 20 having transmitted the request for participation in the conference. The communication unit 307 outputs the received information to the processing unit 310. The communication unit 307 transmits the text information output from the processing unit 310, the past minutes information, or the like to the terminal 20 having transmitted the request for participation.

The authentication unit 308 receives the identification information output from the communication unit 307 and determines whether to permit communication. For example, the conference support device 30 receives registration of the terminal 20 which is used by a participant in the conference and registers the terminal in the authentication unit 308. The authentication unit 308 outputs an instruction for permitting participation in communication or an instruction for not permitting participation in communication to the communication unit 307 according to the determination result.

The operation unit 309 is, for example, a keyboard, a mouse, or a touch panel sensor provided on the first display device 60. The operation unit 309 detects an operation result of a participant and outputs the detected operation result to the processing unit 310.

The processing unit 310 transmits information or the like which is obtained by recognizing every speech of speakers and converting the speech to text to the terminals 20 via the communication unit 307, for example, for every speech. When information on a comment is acquired from a terminal 20, the processing unit 310 performs a process associated with the comment. The processing unit 310 transmits comment display information obtained by performing a process associated with the comment to the terminals 20 via the communication unit 307.

The processing unit 310 reads minutes from the minutes and speech log storage unit 50 in response to instruction information for requesting transmission of past minutes and outputs information of the read minutes to the communication unit 307. The minutes information may include information indicating speakers and information indicating the dependency analysis result.

The presentation information generating unit 312 acquires text information which is the dependency analysis result output form the dependency analysis unit 304. The presentation information generating unit 312 generates information which is displayed on the terminal 20, the first display device 60, or the second display device 70 on the basis of the acquired information.

The comment generating unit 313 performs a process associated with a comment when information on the comment is acquired from the terminal 20. The information on the comment is, for example, identification information of original text of the comment, a voice signal of the comment or text information of the comment, and identification information for identifying the terminal 20 which is used by a user having commented. When a voice signal is acquired, the comment generating unit 313 outputs the acquired voice signal to the voice recognizing unit 302 and acquires text information output from the dependency analysis unit 304. The comment generating unit 313 adds the identification information, information indicating a user having commented, and information indicating a comment to the text of the comment as described above. The comment generating unit 313 transmits all of the original text of the comment, the identification information of the original text of the comment, information indicating a speaker of the original text of the comment, and information indicating display in a text area of the comment as comment display information to the terminals 20 via the communication unit 307.

When the sound collection device 10 is a microphone array, the conference support device 30 further includes a sound source localizing unit, a sound source separating unit, and a sound source identifying unit. In this case, the sound source localizing unit of the conference support device 30 performs sound source localization on the voice signal acquired by the acquisition unit 301 using a predetermined transfer function which has been generated in advance. The conference support device 30 performs speaker identification using the sound source localization result from the sound source localizing unit. The conference support device 30 performs sound source separation on the voice signal acquired by the acquisition unit 301 using the sound source localization result from the sound source localizing unit. The voice recognizing unit 302 of the conference support device 30 performs detection of a speech section and voice recognition on the separated voice signals (for example, see Japanese Unexamined Patent Application, First Publication No. 2017-9657). The conference support device 30 may perform an echo reducing process.

The voice recognition, the text conversion, and the dependency analysis may be performed by the terminal 20. In this case, the terminal 20 may include a voice recognizing unit 207, a text conversion unit 208, and a dependency analyzing unit 209 and perform such processes in cloud.

### [Example of Process Flow]

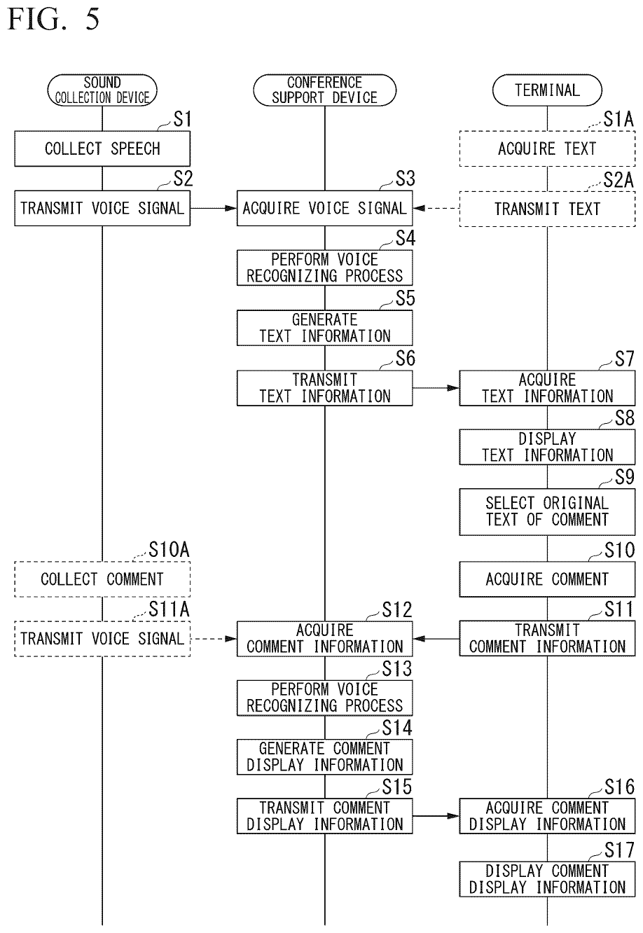

An example of a process flow that is performed by the conversation support system 1 will be described below. FIG. 5 is a flowchart illustrating a process flow that is performed by the conversation support system according to the present embodiment. In FIG. 5, a plurality of terminals 20 are illustrated as a single constituent.

(Step S1) The sound collection device 10 collects a voice signal of a speaker. A user may input speech as text by operating the terminal 20 (Step S1A).

(Step S2) The sound collection device 10 transmits the collected voice signal to the conference support device 30. When text is input to the terminal 20, the terminal 20 transmits the input text to the conference support device 30 (Step S2A).

(Step S3) The conference support device 30 acquires the voice signal transmitted from the sound collection device 10. Alternatively, the conference support device 30 acquires the text transmitted from the terminal 20.

(Step S4) The conference support device 30 performs a voice recognizing process, a text conversion process, a dependency analysis process on the acquired voice signal.

(Step S5) The conference support device 30 adds identification information or the like to the information converted to text and generates text information. Alternatively, the conference support device 30 adds identification information or the like to the text acquired from the terminal 20 and generates text information.

(Step S6) The conference support device 30 transits the generated text information to the terminal 20.

(Step S7) The terminal 20 acquires the text information from the conference support device 30.

(Step S8) The terminal 20 displays the acquired text information on the display unit 204.

(Step S9) The terminal 20 detects that text on which the user want to comment is selected from the displayed text of speech.

(Step S10) When the comment of the user is a voice signal, the terminal 20 acquires a voice signal using the sound collecting unit 202. The voice signal of the comment may be collected by the sound collection device 10 (Step S10A).

Alternatively, when the comment is made by text, the terminal 20 acquires the input text. (Step S11) The terminal 20 transmits identification information of text of original speech of the selected comment and the comment (a voice signal or text) as comment information to the conference support device 30. When a voice signal of a comment is collected by the sound collection device 10, the terminal 20 may transmit the identification information of the text of the original speech of the selected comment to the conference support device 30, and the sound collection device 10 may transmit the voice signal as comment information to the conference support device 30 (Step S11A).

(Step S12) The conference support device 30 acquires comment information from the terminal 20. Alternatively, the conference support device 30 acquires comment information from the terminal 20 and acquires a voice signal of the comment from the sound collection device 10.

(Step S13) When a voice signal is included in the acquired comment information, the conference support device 30 performs a voice recognizing process, a text conversion process, and a dependency analysis process on the acquired voice signal.

(Step S14) As described above, the conference support device 30 adds identification information on the comment converted to text, adds an identification number of the original text of the comment to be displayed in the comment display area, and generates comment display information.

(Step S15) The conference support device 30 transmits the generated comment display information to the terminals 20.

(Step S16) The terminal 20 acquires the comment display information from the conference support device 30.

(Step S17) The terminal 20 displays the acquired comment display information on the display unit 204. In this display, the original text or the like of the comment is displayed in the comment display area as in the image g40 illustrated in FIG. 2.

In the process flow described above with reference to FIG. 5, the processes of the first display device 60, the second display device 70, and the like are omitted, and the text information or the comment display information acquired from the conference support device 30 may be displayed on such display devices similarly to the terminal 20.

In the aforementioned example, full original text of the comment is selected as designated text, but the present invention is not limited thereto. Text which is selected as designated text may be a part of speech. For example, text of the third speech (image g13) in FIG. 2 “Today, empty from 14:00” is first selected as a comment target, and then a part of the text, for example, “from 14:00” may be selected. In this case, an example of the comment may be “Not from 15:00?.”

As described above, in this embodiment, speech text on which a user wants to comment is displayed, and the user who wants to comment is allowed to select a comment target. Then, in this embodiment, when speech (a voice or text) is made in the selected state, the selected speech is also displayed.

Accordingly, according to the present embodiment, designated text is displayed along with input speech text by designating a part of whole of input text through a touch and inputting a voice (or inputting text) in the designated state. Accordingly, according to the present embodiment, it is possible to easily understand with what part a comment is associated and to easily understand context.

### Second Embodiment

In the first embodiment, a comment is made once, but a user may want to comment on a comment. Accordingly, in this embodiment, it is assumed that a comment is made a plurality of times. The configuration of the conversation support system 1 is the same as the configuration according to the first embodiment illustrated in FIG. 4.

### [Example of Operation and Display in Terminal]

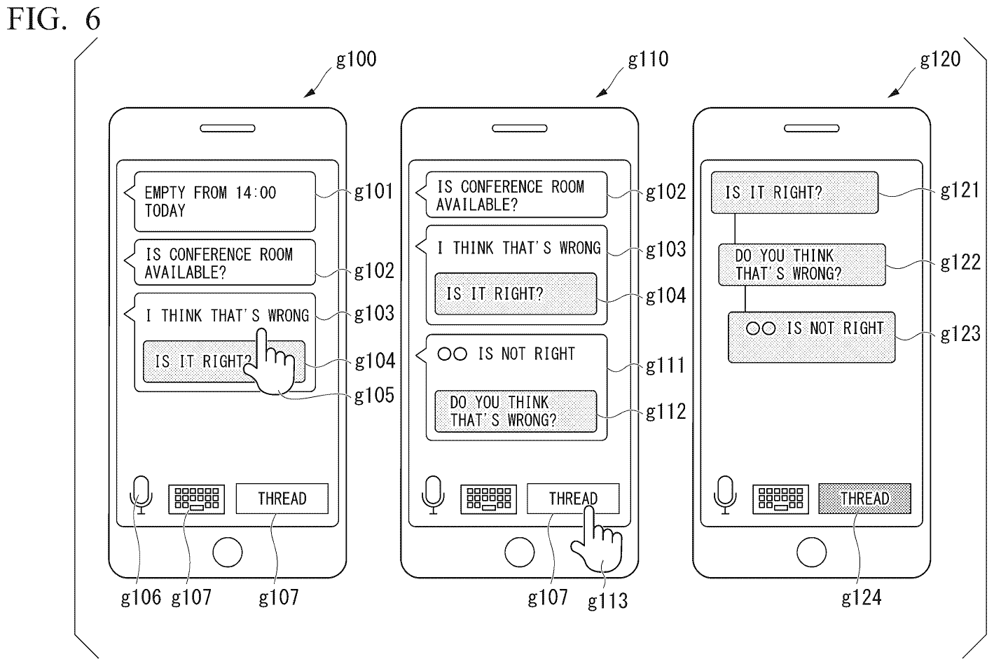

An example of an image and an example of an operation displayed on a terminal 20 will be described below with reference to FIG. 6. FIG. 6 is a diagram illustrating an example of an image of an example of an operation which are displayed on a terminal according to the present embodiment.

An image g100 indicates a state in which a second comment is made after a first comment has been input and displayed on the display unit 204 of the terminal 20.

Images g101 and g102 are examples of text images of speech before the comment has been input.

An image g103 is an example of comment, and text which is a comment target (an image g104) is displayed in the comment display area.

An image g105 is an image of a user's finger and indicates a state in which selection for the second comment is performed. In this example, the comment (image g103) “I think that's wrong.” is selected.

An image g106 is an example of a voice recognition button image. An image g107 is an example of a text input button image

The image g107 is an example of a thread display button image for thread-displaying a plurality of comments.

An image g110 is an example of an image which is displayed on the terminal 20 after the second comment has been input. An image g111 is an example of text of the second comment and is a comment on the first comment (image g103) “I think that's wrong.” In the second comment, an image g112 of original text of the comment is displayed in the comment display area.

In this display, when a user wants to thread-display comments, the thread display button image g107 is selected (image g113).

An image g120 is a display example in which the first and second comments are displayed in a thread manner. As in this display, the terminal 20 displays a text image g122 of the first comment and a text image g123 of a comment on the first comment in a thread manner with an image g121 of the original text of the comment as a parent. In the thread display, a display state of the thread display button image may be displayed to be different from that before it is selected (image g124).

Information of this thread display is generated and transmitted to the terminal 20 by the conference support device 30.

The display image illustrated in FIG. 6 is only an example, and an icon, a name, or the like indicating a speaker may be displayed in correlation with each comment.

### [Example of Process Flow]

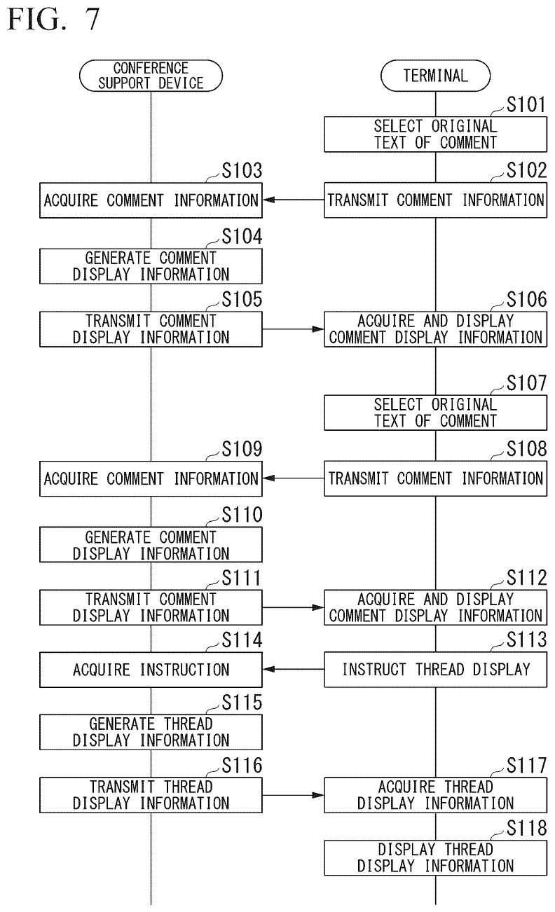

An example of a process flow that is performed by the conversation support system 1 will be described below. FIG. 7 is a flowchart illustrating a process flow that is performed by the conversation support system according to the present embodiment. In FIG. 7, a plurality of terminals 20 are illustrated as a single constituent. The process flow illustrated in FIG. 7 is performed in a state in which some pieces of speech are uttered and text of speech is displayed on the display unit 204 of the terminal 20.

(Step S101) The terminal 20 detects that text on which a user wants to comment is selected from the displayed text of speech. Subsequently, when the comment from the user is a voice signal, the terminal 20 acquires the voice signal using the sound collecting unit 202. The voice signal of the comment may be collected by the sound collection device 10. When the comment is made by text, the terminal 20 acquires the input text.

(Step S102) The terminal 20 transmits identification information of text of original speech of the selected comment and the comment (a voice signal or text) as comment information to the conference support device 30. When the sound collection device 10 collects the voice signal of the comment, the terminal 20 transmits identification information of the text of the original speech of the selected comment to the conference support device 30, and the sound collection device 10 may transmit the voice signal as comment information to the conference support device 30.

(Step S103) The conference support device 30 acquires the comment information from the terminal 20. Alternatively, the conference support device 30 acquires the comment information from the terminal 20 and acquires the voice signal of the comment from the sound collection device 10.

(Step S104) When a voice signal is included in the acquired comment information, the conference support device 30 performs a voice recognizing process, a text conversion process, and a dependency analysis process on the acquired voice signal. Subsequently, the conference support device 30 adds identification information to the comment converted to text, adds an identification number of the original text of the comment to be displayed in the comment display area, and generates comment display information.

(Step S105) The conference support device 30 transmits the generated comment display information to the terminals 20.

(Step S106) The terminal 20 acquires the comment display information from the conference support device 30. Subsequently, the terminal 20 displays the acquired comment display information on the display unit 204.

(Steps S107 to S112) The terminal 20 and the conference support device 30 perform the processes of Steps S107 to S112 as the second comment processing in the same way as in Steps S101 to S106.

(Step S113) The terminal 20 detects that the thread display button image is selected. Subsequently, the terminal 20 transmits information indicating that thread display is instructed to the conference support device 30.

(Step S114) The conference support device 30 acquires the information indicating that thread display is instructed from the terminal 20.

(Step S115) The conference support device 30 generates thread display information for display, for example, as illustrated in the image g120 of FIG. 6.

(Step S116) The conference support device 30 transmits the generated thread display information to the terminal 20 having transmitted the instruction.

(Step S117) The terminal 20 acquires the thread display information from the conference support device 30.

(Step S118) The terminal 20 displays the thread display information on the display unit 204, for example, as illustrated in the image g120 of FIG. 6.

In the example illustrated in FIG. 7, a comment is made two times, but the number of times a comment is made may be one or three or more. The conversation support system 1 may perform thread display even when the number of times a comment is made is one.

When minutes are stored in the minutes and speech log storage unit 50, the conference support device 30 may store information on the number of times a comment is made or thread information which is added to the minutes.

As described above, in the present embodiment, even when a comment on a comment is additionally input, the comment and the comment target may be displayed in correlation. In the present embodiment, comments are displayed in a thread manner.

Accordingly, according to the present embodiment, since a relationship between a comment and a comment target can be easily understand even when comments are input a plurality of times, it is possible to easily understand the context of the comments. According to the present embodiment, since thread display can be performed, it is possible to easily understand speech serving as a basis of a comment or a time series of comments even if a user additionally comments on a comment.

In the aforementioned embodiments, instructions or operations are performed by the terminal 20, but may be performed, for example, by the PC 80.

Some or all of the processes which are performed by the terminal 20 and the conversation support device 30 may be performed by recording a program for realizing all or some of the functions of the terminal 20 and the conversation support device 30 according to the present invention on a computer-readable recording medium and causing a computer system to read and execute the program recorded on the recording medium. The “computer system” mentioned herein includes an operating system (OS) or hardware such as peripherals. The “computer system” may include a WWW system including a homepage provision environment (or a homepage display environment). The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that holds a program for a predetermined time such as a volatile memory (RAM) in a computer system serving as a server or a client when the program is transmitted via a network such as the Internet or a communication line such as a telephone line.

Some or all of these elements may be realized by hardware (a circuit unit including circuitry) such as a large scale integration (LSI) circuit, an application-specific integrated circuit (ASIC), a field-programmable gate array (FPGA), a graphics processing unit (GPU) or a system on chip (SOC) or may be cooperatively realized by software and hardware.

The program may be transmitted from a computer system in which the program is stored in a storage device or the like to another computer system via a transmission medium or carrier waves in the transmission medium. Here, the “transmission medium” for transmitting a program is a medium having a function of transmitting information such as a network (a communication network) such as the Internet or a communication circuit line (a communication line) such as a telephone line. The program may be a program for realizing some of the aforementioned functions. The program may be a so-called differential file (a differential program) that can realize the aforementioned functions in combination with another program stored in advance in the computer system.

While a mode for realizing the present invention has been described above with reference to an embodiment, the present invention is not limited to the embodiment and can be subjected to various modifications and replacements without departing from the gist of the present invention.

What is claimed is:

1. A conversation support device comprising:
an acquisition unit configured to acquire speech;
a display unit configured to display text based on the acquired speech; and
a control unit configured to cause the display unit to display the text based on the speech,
wherein the control unit recognizes a piece of text selected by a user out of a plurality of pieces of the text displayed on the display unit as designated text, and
wherein the control unit causes the display unit to display speech associated with the designated text in correlation with the designated text when the speech associated with the designated text is input in a state in which the designated text has been recognized.

2. The conversation support device according to claim 1, further comprising a text conversion unit configured to convert the speech to text when the speech is a voice signal,
wherein the acquisition unit acquires a voice signal when the speech is a voice signal and acquires text when the speech is text, and
wherein the control unit assigns identification information to the converted text or the acquired text and causes the display unit to display the speech associated with the designated text in correlation with the designated text on the basis of the identification information of the text designated by a user out of the plurality of pieces of text displayed on the display unit.

3. The conversation support device according to claim 1, wherein the control unit displays the speech associated with the designated text in an area in which the designated text is displayed.

4. The conversation support device according to claim 1, wherein the control unit causes the display unit to thread-display a relationship between the speech associated with the designated text and the designated text when a thread display instruction is given.

5. The conversation support device according to claim 1, wherein the designated text is full or partial text of the speech.

6. A conversation support system comprising:
a terminal; and
a conference support device,
wherein the terminal includes
an acquisition unit configured to acquire speech,
a display unit configured to display text based on the acquired speech, and
a processing unit configured to transmit information on the acquired speech to the conference support device, to acquire the text based on the speech, to cause the display unit to display the text acquired from the conference support device, to recognize a piece of text selected out of a plurality of pieces of the displayed text as designated text, to transmit information indicating the designated text and speech associated with the designated text to the conference support device when the speech associated with the designated text is input in a state in which the designated text has been recognized, and to cause the display unit to display comment display information in which the information indicating the designated text and the speech associated with the designated text are correlated and which is acquired from the conference support device, and
wherein the conference support device includes
a conversion unit configured to convert a voice signal to text when the speech acquired from the terminal is the voice signal,
a comment generating unit configured to acquire information indicating the designated text and speech associated with the designated text and to generate the comment display information in which the speech associated with the designated text is correlated with the designated text, and
a processing unit configured to transmit the generated comment display information to the terminal.

7. A conversation support method comprising:
causing an acquisition unit to acquire speech;
causing a display unit to display text based on the acquired speech;
causing a control unit to recognize a piece of text selected by a user out of a plurality of pieces of the text displayed on the display unit as designated text; and
causing the control unit to display speech associated with the designated text in correlation with the designated text when the speech associated with the designated text is input in a state in which the designated text has been recognized.

8. A non-transitory computer-readable storage medium storing a program causing a computer to perform:
acquiring speech;
generating text based on the acquired speech to be displayed;
displaying the text on a display unit;
recognizing a piece of text selected by a user out of a plurality of pieces of the text displayed on the display unit as designated text; and
displaying speech associated with the designated text on the display unit in correlation with the designated text when the speech associated with the designated text is input in a state in which the designated text has been recognized.
